(19) United States
(12) Patent Application Publication
(10) Pub. No.: US 2008/0201481 A1
(43) Pub. Date: Aug. 21, 2008

(54) Remote interface marshalling

(75) Inventors: Makarand V. Patwardhan, Redmond, WA (US); Vladimir K. Stoyanov, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/708,219

(22) Filed: Feb. 20, 2007

(51) Int. Cl. G06F 15/16

(52) U.S. Cl. 709/228

(57) ABSTRACT

A remote interface marshalling (“RIM”) platform is provided in which a protocol interface described using an interface definition language (“IDL”) is parsed to automatically generate the appropriate communication packets and a protocol layer to enable communication between terminal server components. Use of the RIM platform advantageously enables a developer to create a new terminal services protocol simply by writing the interface definition (i.e., describe the input/output) using the well-known IDL language which is well supported on virtually all computing platforms. The RIM platform further provides for robust versioning support by providing the developer with an ability to create a new interface that is derived from an existing interface.

### BACKGROUND

It is a common practice when adding new features and capabilities to a terminal services (“TS”) client and terminal server to write software components that are installed on both the terminal server and client sides to enable communication between the client and server by exchanging packets or messages with specific content. Typically, the TS protocol which describes the format and content of these packages is privately established by the components during the design phase of their development and typically have the following specifications: versioning, custom marshalling, security checks, request-reply identification, client/server reversibility, reusability and documentation. Because all the effort for creating new TS protocols is normally manual, significant resources must be expended to handle all the aspects listed above. This situation often results in the generation of complicated, one-time use, error-prone code. Moreover, the addition of new features and capabilities often does not scale well as the feature complexity increases.

This Background is provided to introduce a brief context for the Summary and Detailed Description that follows. This Background is not intended to be an aid in determining the scope of the claimed subject matter nor be viewed as limiting the claimed subject matter to implementations that solve any or all of the disadvantages or problems presented above.

### SUMMARY

A remote interface marshalling (“RIM”) platform is provided in which a protocol interface described using an interface definition language (“IDL”) is parsed to automatically generate the appropriate communication packets and a protocol layer to enable communication between terminal server components. Use of the RIM platform advantageously enables a developer to create a new TS protocol simply by writing the interface definition (i.e., describe the input/output or “I/O”) using the well-known IDL language which is well supported on virtually all computing platforms. The RIM platform further provides for robust versioning support by providing the developer with an ability to create a new interface that is derived from an existing interface.

In an illustrative example, the RIM platform involves two parts: 1) a RIM compiler which generates RIM code from an input TLB (type library) file to serialize all interface methods in a series of calls to a RIM protocol layer, and 2) the RIM protocol layer which maintains unique IDs for all objects and requests on both the terminal server and client sides. The RIM protocol layer also implements simple primitives for communicating basic scalar data types.

The present RIM platform advantageously streamlines the development of new TS protocols. By automatically generating the TS protocol, much of the manual labor associated with the development is eliminated, leaving the developer to focus on solving problems instead of developing protocol infrastructure. As a result, the development is faster and the resulting code is more robust.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative environment in which the present RIM platform may be applied;

FIG. 2 shows an illustrative RIM compiler that generates RIM code from an input TLB file;

FIG. 3 is a UML (Unified Modeling Language) representation of an illustrative RIM protocol layer;

FIG. 4 is a flowchart of an illustrative method which is invoked as part of a user interface for which the only input parameter passed is an interface method; and

FIG. 5 is a flowchart showing an illustrative remote side process which corresponds to the method invoked in the flowchart of FIG. 4.

Like reference numerals indicate like elements in the figures.

### DETAILED DESCRIPTION

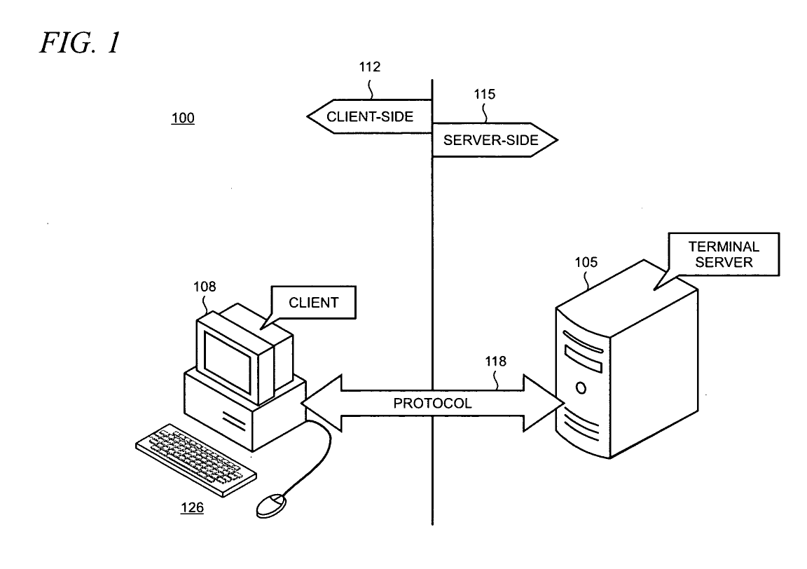

FIG. 1 is a diagram of an illustrative environment 100 supporting a terminal services session between a terminal server 105 and a client computer 108 in which the present RIM platform may be applied. Environment 100 is divided into a client-side and a server-side, respectively, as indicated by reference numerals 112 and 115. Terminal server 105 on the server-side 115 operatively communicates with the client computer 108 on the client-side 112 using a protocol 118. In this illustrative example, protocol 118 is arranged to use a Remote Desktop Protocol (“RDP”) that typically operates over a TCP/IP (Transmission Control Protocol/Internet Protocol) connection between the client computer 108 and terminal server 105. RDP is able to be configured to support multiple simultaneous TS sessions using a dynamic virtual channel (“VC”) arrangement.

Terminal services provide functionality similar to a terminal-based, centralized host, or mainframe environment in which multiple terminals connect to a host computer. Each terminal provides a conduit for input and output between a user and the host computer. A user can log on at a terminal, and then run applications on the host computer, accessing files, databases, network resources, and so on. Each terminal session is independent, with the host operating system managing multiple users contending for shared resources.

The primary difference between terminal services and the traditional mainframe environment is that the terminals in a mainframe environment only provide character-based input and output. A remote desktop client or emulator provides a complete graphical user interface, including a Microsoft Windows® operating system desktop and support for a variety of input devices, such as a keyboard and mouse, collectively identified by reference numeral 126 in FIG. 1.

In the terminal services environment, an application runs entirely on the terminal server. The remote desktop client performs no local execution of application software. The server transmits the graphical user interface to the client. The client transmits the user's input back to the server.

Components respectively installed in the terminal server 105 and client 108 in environment 100 exchange communication packets in support of the TS session. As noted above the format and content of these packets is typically privately established by the components during the design phase of their development and have the following specifications:

Versioning. To be able to improve the TS protocol, typically a versioning or capabilities packet is introduced by the component to resolve backwards and forward compatibility.

Marshalling. Any data of variable length has historically required manual coding on both the client side 112 and server side 115 by a developer who is implementing the component.

Security Checks. Special checks for invalid data must be performed by the packet parser in order to avoid attacks from malicious users. Although these checks are typically trivial, because of the historic need to manually develop the code it can be prone to errors, where the level of errors typically depended on the developer's experience. A common technique to mitigate this problem has been to run code analysis tools, which has typically resulted in fixing bugs late in the shipping cycle which can delay product releases and add costs.

Request-Reply Identification. Historically, the TS protocol consists of a request-reply packet pair, for example one side sends a “request” packet for executing the operation on the other side, and any output data from the operation is sent from the remote side as a “reply” packet. If the “request-reply” is executed asynchronously, an identification for the request must be added to the protocol, which increases the protocol complexity, which may result in more bugs.

Reversibility. Since TS protocols have historically been implemented by hand, it certainly has asymmetric nature from the start. Although rare, in some instances the TS protocol has to work backwards, for example, when the TS protocol implements file redirection from a client to a server. If a developer wants to add a server to the client file redirector, the developer must implement substantially from scratch all packets going the other way. If a “request” packet was being sent by the server and client replies with a “reply” packet, both sides have to add code to handle these packets in reverse manner.

Reusability. As a result of the manual nature of the protocol, parts of it are generally difficult to reuse. For example, a subset of the protocol for audio playback may be desired to be reused by multimedia playback. This generally results in a doubling of the effort for adding new features and losing the opportunity to specialize protocol fragments.

Documentation. Developers are often forced to create documentation for their protocols which adds extra labor into the development. Frustration and mistakes in the documentation are possible outcomes.

A specific example is now provided to highlight several of the design issues noted above. An existing feature provided by the Microsoft Windows® operating system is PnP (Plug and Play) redirection where calls from an application on the terminal server 105 are redirected to a local device coupled to the client 108. One of the PnP direction calls is DeviceIOcontrol which has three input parameters: a file handle, and input buffer, and an input buffer size. The call also has three output parameters: an output buffer, the output buffer size, and the result code. The call must be executed asynchronously with possible cancellation. If the call were to be coded manually, a developer would need to describe four different protocol packets:

1) A request packet that must contain the following fields: a unique file ID, unique request ID, variable length input parameter blob, and a maximum size of output parameter;

2) An I/O control result packet for starting the communication I/O: a request ID (from 1 above), cancellation ID and status error code;

3) A cancellation packet (this packet is sent in order to cancel the request (from 1)): a request ID (from 1) and cancellation ID (from 2); and

4) A completion packet: this packet is sent when the I/O completes (or has been cancelled): request ID, status error code, and variable length output parameter.

Designing these four packets is not a trivial problem. And while experienced developers may be able to come up with a design fairly quickly, they may also miss some aspects. For example, keeping all of the IDs noted above unique is a nontrivial problem and may often lead to some serious synchronization bugs, like canceling a request that is different from the one intended.

The present RIM platform is arranged to automate major portions of the development of interface marshalling between the terminal server 105 and the client computer 108 while addressing the design issues noted in the specifications above. Rather than having to design the communication packets to create the TS protocol, the developer only has to describe the I/O using the IDL language. IDL works by requiring that a program's interfaces be described in a stub that is compiled into it. The stubs in each program are used by a broker program to allow them to communicate. The IDL file used in this example is shown below:

```
Interface ITSPnPFile : IUnknown
    HRESULT DeviceIoControl(
        [in, size_is(cbInSize)] BYTE *pInBuffer,
```

| | |
|---|---|
| [in] | ULONG cbInSize, |
| [in] | ULONG cbMaxOutSize, |
| [in] | IAsyncResult *pResult, |
| [out] | IAsyncCancel **ppCancel ); |

Interface IAsyncResult : IUnknown
HRESULT IoComplete(

| | |
|---|---|
| [in,size_is(cbOutSize)] | BYTE *pOutBuffer, |
| [in] | ULONG cbOutSize, |
| [in] | HRESULT status ); |

Interface IAsyncCancel: IUnknown
HRESULT CancelIo( );

From the interfaces defined in the IDL file, the RIM platform will automatically generate the appropriate packets and protocol layer. The above example also highlights the versioning capability noted above. If a developer wishes to add a second variable length input parameter to the device I/O control call, the developer normally must have included a versioning packet in the first implementation in order to do some special handling based on the remote version. In the present arrangement, the developer only needs to create a new interface that is derived from the old one by adding a “QueryInterface” call for the new version.

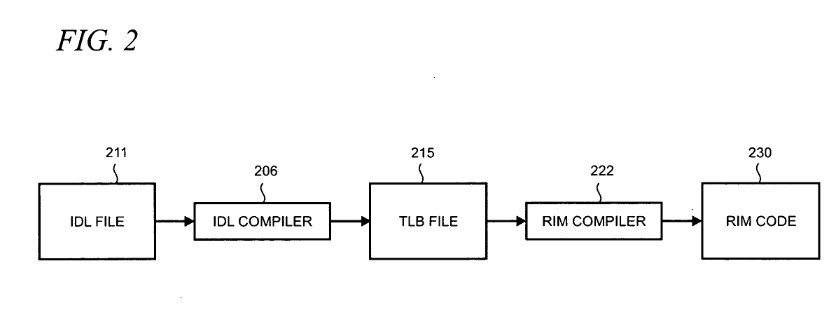

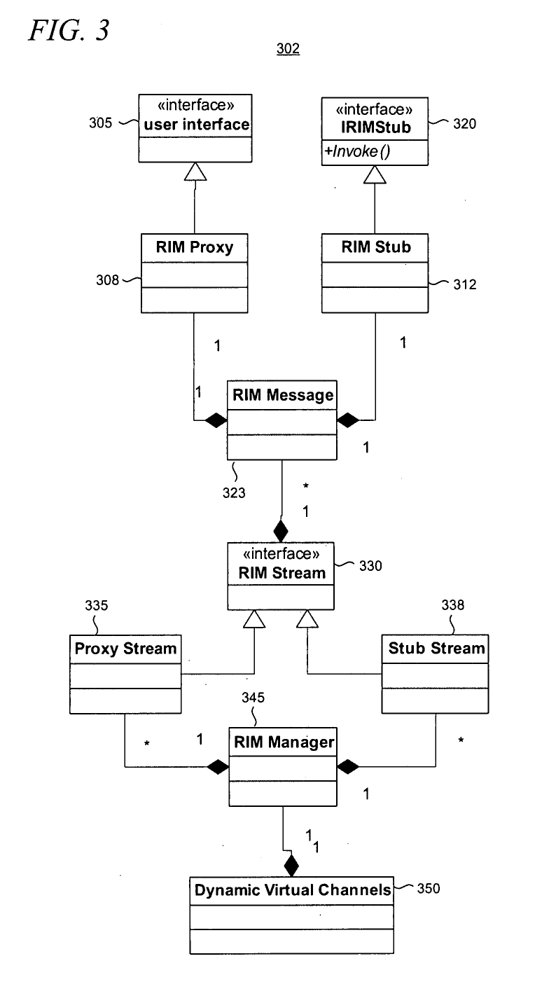

As shown in FIG. 2, an IDL compiler 206 receives the IDL file 211 as an input and generates a TLB file 215. A RIM compiler 222 is arranged to compile the TLB file 215 to produce RIM code 230 at a compile time for a particular project for marshalling all interfaces and associated structures. The RIM code 230 serializes all TS interfaces using a series of calls into a RIM protocol layer (shown in FIG. 3 and described in the accompanying text).

The IDL file 211 describes all data types, and interfaces with their associated methods. A variety of different data types are typically utilized as shown below:

Scalar type. This is any predefined fixed size language data type, specifically—char, short, int, long or an array of any of these.

scalar=char|short|int|long|guid|scalar[ ]

User defined type. This is a compound type that contains any number of scalar types or any other user type. A typical example of that is structures in C/C++ language.

usertype={scalar|usertype}

Strings. These are single or double char null terminated arrays.

string=char*|wchar*

Unknown. This describes a base interface that only has reference counting and QueryInterface methods. Interfaces that inherit from Unknown are also of this data type. All interfaces that can be remoted by the RIM platform should normally implement from this interface.

unknown=IUnknown|object:IUnknown

Reference type. This could be any a reference to any other type including a recursive reference.

ref=*<type>

Direction. A parameter can be either input or output, this has special relation with the reference type. For example, output parameters should have at least a single level of reference.

dir = in | out
type = <scalar>|<usertype>|<string>|<unknown>|<ref>

Parameters can also have a relation between each other. For example, one parameter can specify the length of an array parameter in a single call. These are marked with a “size_is” attribute, where the parameter inside the “size_is” attribute specifies the number of items in the array. Table 1 lists an illustrative full set of parameters that may be used by the present RIM platform. Table 2 lists a set of illustrative examples of parameter variation.

TABLE 1

| | | size_is | size_is | |
|---|---|---|---|---|
| i/o | param type | i/o | type | comment |
| in | <scalar> | — | — | input scalar |
| in, out | ref<scalar> | — | — | input/output scalar type |
| in | ref<scalar> | in | <scalar> | input array of scalars |
| in | ref<usertype> | — | — | input user type |
| in | ref<usertype> | in | <scalar> | input array of usertype |
| in | string | — | — | input string |
| in | ref<string> | in | <scalar> | input multiple strings |
| in | ref<unknown> | — | — | input of lunknown object |
| in | ref<unknown> | in | <scalar> | input array of lunknown |
| | | | | objects |
| out | ref<scalar> | — | — | output scalar |
| out | ref<scalar> | in, out | ref<scalar> | output array of scalars, |
| | | | | max_is == size_is( input ) |
| | | | | callee allocated |
| out | ref<string> | — | — | output of string, callee |
| | | | | allocated |
| out | ref<usertype> | — | — | output user type |
| out | ref<usertype> | in, out | ref<scalar> | output user type, caller |
| | | | | allocated, max_is == size_is( input ) |
| out | ref<ref<usertype>>> | out | ref<scalar> | output array of usertype, |
| | | | | callee allocated |
| out | ref<ref<unknown>> | — | — | output unknown object |
| out | ref<ref<unknown>> | in, out | ref<scalar> | output array of objects, |
| | | | | max_is == size_is(input) |
| | | | | caller allocated |
| out | ref<ref<ref<unknown>>> | out | ref<scalar> | output array of objects, |
| | | | | callee allocated |

TABLE 2
Example

| | | | | | | |
|---|---|---|---|---|---|---|
| SetMilage | [in] | long | IMilage | | | |
| NegotiatePrice | [in, out] | long * | plAskingPrice | | | |
| SendBlob | [in, size_is(numArray)] | char * | pBlob | [in] | long | numArray |
| SetOneRecord | [in] | _RECORD * | pPersonRecord | | | |
| SetRecords | [in, size_is(numRects)] | _RECT * | pRects | [in] | ULONG | numRects |
| PrintF | [in, string] | char * | hello | | | |
| PrintText | [instring, size_is(n) | wchar_t ** | pszText | [in] | short | n |
| OnCreatedSession | [in] | ITSSession * | pSession | | | |
| SetSessions | [in, size_is(arrsize)] | ITSSession ** | ppSessions | [in] | int | arrsize |
| GetLength | [out] | short * | psLength | | | |
| GetData | [out, size_is(psize)] | char ** | pbData | [in, out] | short * | psize |
| GetName | [out, string] | char ** | pszName | | | |
| GetRecord | [Out] | _RECORD * | pPersonRecord | | | |
| GetClipRect | [out, | _RECT * | pClipArray | [in, out] | char * | pClipSize |
| | size_is(pClipSize)] | | | | | |
| GetClipArea | [out, | _RECT ** | ppClipArray | [out] | char * | pClipSize |
| | size_is(pClipSize)] | | | | | |
| GetSession | [out] | ITSSession ** | ppSession | | | |
| EnumSessions | [out, size_is(numSess)] | ITSSession ** | ppSessionList | [in, out] | int * | numSess |
| GetAll | [out], size_is(numAll) | IUnknown *** | pppAll | [out] | long * | numAll |

FIG. 3 is a UML (Unified Modeling Language) representation of an illustrative RIM protocol layer 302. In this representation, the RIM generated code is located in the RIM proxy 308 and RIM stub 312 components.

Each method in the IDL file 211 (FIG. 2) generates two pieces of code: proxy and stub. The RIM proxy is a method that a RIM user can call, through the user interface 320, and is arranged to have the same signature as described in the IDL compiler. It can be called at any point of the execution. The RIM proxy performs the following steps: 1) Pick up all input parameter packets and send them using the protocol layer 302; 2) Wait for a reply packet; 3) Unpack and fill out all output parameters and return a result; and 4) Return.

The RIM stub is implemented on the remote side. It is noted that it does not matter whether the implementation is performed on the client 108 (FIG. 1) or terminal server 105 (FIG. 1), as the steps performed are completely symmetric (i.e., either the client or server may be considered as the “remote” side). The RIM stub performs the following steps: 1) Unpack and fill out all input parameters; 2) Invoke the real function that the remote side wants to invoke through the IRIMStub interface 320; 3) Pack all output parameters and return code; and 4) Send the result from Step 3 using the RIM protocol layer 302.

For example, given the following method:

HRESULT MoneyExchange( [in] ULONG UsDollars,
[out] ULONG *Euro, [in] float ExchangeRate )

the RIM proxy will generate a packet that contains the value of “UsDollars” and “ExchangeRate”. The RIM stub will receive that packet and invoke the implementation of MoneyExchange. The output of that call will be “Euro” and HRESULT is returned. The RIM stub will send back a reply with these two values. The RIM proxy will pick up the “Euro” and set the output parameter with that value. The RIM proxy will then exit with the return code from the packet.

The RIM protocol layer 302 includes functionality to support a series of methods for sending different scalar data types, strings, and interfaces, each of which has a very specific wire format, to thereby eliminate confusion, for example, as to how many bits a particular integer utilizes. The RIM protocol layer 302 exposes the functionality to the RIM-generated code through an interface named “RIM message,” as indicated by reference numeral 323 in FIG. 3. The RIM message 323 interfaces through a RIM stream 330 (having both a proxy stream component 335 and stub stream component 338) with a RIM manager 345 in order to pass communications over the dynamic virtual channel 350 of the RDP protocol. Such interface examples include:

| | |
|---|---|
| WriteINT16/ReceiveINT16 | this pair writes/receives a 16 bit integer |
| WriteLPSTR/ReceiveLPSTR | send and receive null terminated ASCII |
| | strings |

For sending/receiving interfaces, the following methods are used:

```
HRESULT
WriteIUnknown(
    [in, size_is(n)] IUnknown **p,
    [in] REFIID riid,
    [in] ULONG n );
```

This method serializes “n” number of interfaces that have interface ID “riid”. The protocol layer generates a unique ID for this interface and stores the IUnknown pointer “p” associated with that ID. It also generates a RIM stub and associates it with the interface ID and the actual pointer “p.”

When remote side receives this ID by calling

```
HRESULT
ReceiveIUnknown(
    [out, size_is(n)] IUnknown **p,
    [in] REFIID riid,
    [in] ULONG n );
```

it picks up the interface ID from the wire and looks for any pre-existing interface associated with that ID. If the interface ID has just been created, the remote side will not find it and it will be forced to create a proxy, based on the value of “riid”. This means that the code for creating proxies must be available for all interfaces that are being passed.

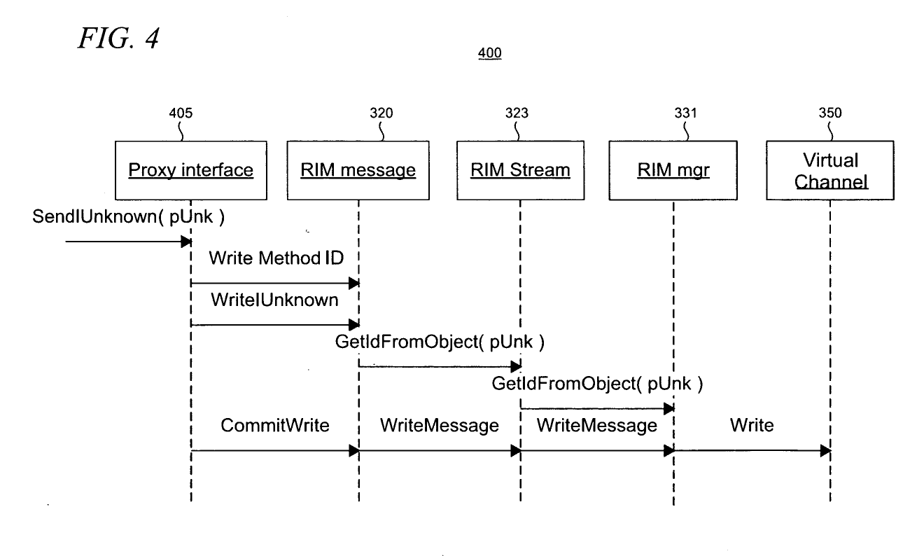

FIG. 4 is a flowchart of an illustrative method 400 called SendIUnknown which is invoked as part of a user interface for which the only input parameter passed is an interface method. As part of the interface marshaling on the remote side, a new proxy is created to the marshaled object, so from that point on, any required methods are invoked automatically. As shown, a proxy interface 405 that is serialized using the sending/receiving interface method noted above passes the interface ID along the components in the protocol layer including the RIM message 320, RIM stream 323, RIM manager 331 and the virtual channel 350.

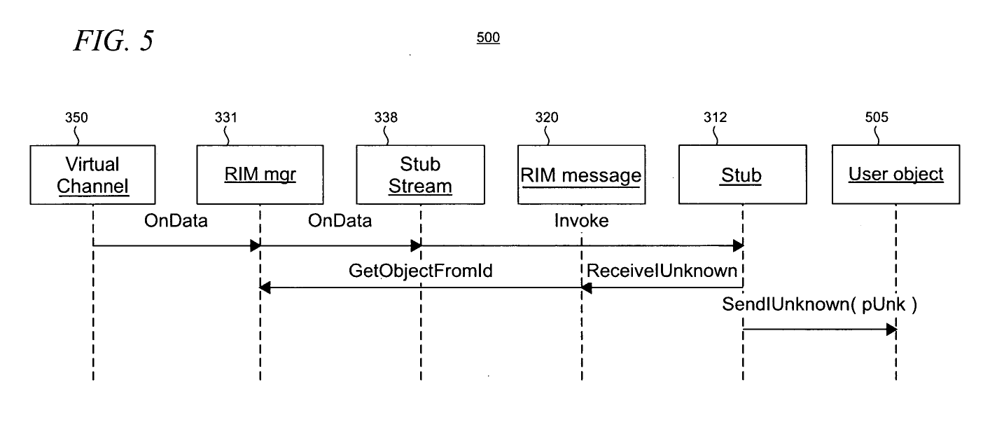

At the remote side, as shown in FIG. 5, the incoming packet is unpacked and the SendIUnknown is invoked by the stub 312 to generate user object 505 which enables calls to be handled as if the object were present locally.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable medium containing instructions which, when executed by one or more processors disposed in an electronic device, perform a method for remote interface marshalling, the method comprising the steps of:
implementing a remote interface marshalling compiler arranged for receiving a library file as an input, the library file specifying one or more interfaces to be remotely marshaled and methods associated with the one or more interfaces; and
compiling the library file to produce runtime code that, when executed, generates method calls through a protocol layer to thereby marshal an interface to a remote component in an automated manner.

2. The computer-readable medium of claim 1 in which the remote component is a remote terminal services component.

3. The computer-readable medium of claim 2 in which the remote terminal services component exchanges data with a local terminal services component.

4. The computer-readable medium of claim 3 further including instructions that implement the protocol layer.

5. The computer-readable medium of claim 4 in which the protocol layer is arranged for maintaining identification for all objects and requests contained in the data exchanged between the local and remote terminal services components.

6. The computer-readable medium of claim 5 in which the protocol layer is further arranged for generating data types for exchanging the data.

7. The computer-readable medium of claim 6 in which the data types are selected from one of scalar type, user-defined type, strings, reference type, directions, or unknown data type.

8. A computer-readable medium containing instructions which, when executed by one or more processors disposed in an electronic device, perform a method for remote interface marshalling, the method comprising the steps of:
generating a proxy by compiling a file containing one or more objects representative of a user-defined I/O description, the proxy being arranged for marshalling an interface to a remote component among components operating in a terminal services environment;
generating a stub by compiling the file, the stub being arranged for running on the remote component, and further arranged for invoking a method specified through the interface;
embedding the proxy and stub in a protocol layer that interfaces between a communications channel and terminal services components, the protocol layer being arranged for generating requests or replies responsively to the user-defined I/O description.

9. The computer-readable medium of claim 8 in which the file is a library file generated through the compilation of user-specified instructions applicable to the I/O description.

10. The computer-readable medium of claim 9 in which the library file is a TLB file.

11. The computer-readable medium of claim 9 in which the user-specified instructions are written using an interface definition language.

12. The computer-readable medium of claim 11 in which the interface definition language comprises IDL.

13. The computer-readable medium of claim 8 in which terminal services communicate over a virtual channel using a remote desktop protocol.

14. The computer-readable medium of claim 8 in which the generating of requests or replies is performed in an automated manner without user intervention at runtime.

15. A method for marshalling an interface between remotely-distributed components in a terminal services environment, the method comprising the steps of:
developing an I/O scenario for communications to be exchanged between the remotely-distributed components associated with provisioning of a terminal services feature; and
generating runtime code using a compiler, the runtime code being arranged for serializing one or more interface methods invoked by the components when executing at least a portion of the I/O scenario when the terminal services feature is executing in the environment.

16. The method of claim 15 in which the developing is substantially performed during a development process associated with the terminal services feature.

17. The method of claim 15 in which the communications comprise one or more packets, the packets being selected from one of request packet, I/O control result packet, cancellation packet, versioning packet, capabilities packet or completion packet.

18. The method of claim 17 in which the one or more packets include at least one unique ID, the ID being selected from one of file ID, request ID, or cancellation ID.

19. The method of claim 17 in which the versioning packet or capabilities packet provides an interface that is derived from an existing interface through application of a query interface call.

20. The method of claim 15 in which the serializing comprises formation of a series of calls to a protocol layer operating between the components and a terminal services transport protocol.
